(19) United States
(12) Patent Application Publication
(10) Pub. No.: US 2015/0023799 A1
(43) Pub. Date: Jan. 22, 2015

(54) Structural Member with Pultrusions

(71) Applicants: Kyle K. Wetzel, Lawrence, KS (US); Ryan Michael Barnhart, Lenexa, KS (US); Teeyana S. Wullenschneider, Baldwin City, KS (US); Alexander R. Tran, Lenexa, KS (US); Ken T. Lee, Austin, TX (US)

(72) Inventors: Kyle K. Wetzel, Lawrence, KS (US); Ryan Michael Barnhart, Lenexa, KS (US); Teeyana S. Wullenschneider, Baldwin City, KS (US); Alexander R. Tran, Lenexa, KS (US); Ken T. Lee, Austin, TX (US)

(21) Appl. No.: 13/946,122

(22) Filed: Jul. 19, 2013

(51) Int. Cl. F03D 1/06

(52) U.S. Cl. CPC F03D 1/0675
USPC 416/226; 416/229 R

(57) ABSTRACT

Disclosed is an engineered structure which includes pultrusions usable for resisting a bending load.

### BACKGROUND

1. Field

Example embodiments relate to a structure that includes pultrusions. A nonlimiting example of the structure is a wind turbine blade having pultrusions incorporated into the wind turbine blade's spar caps. Another nonlimiting example of the structure is a wind turbine blade having pultrusions configured to reinforce at least one of a tail and a nose of the wind turbine blade. Another nonlimiting example of the structure is a wind turbine blade having pultrusions configured to reinforce a shell of a wind turbine blade. Another nonlimiting example of the structure is a wind turbine blade having pultrusions configured to reinforce a web of the wind turbine blade.

2. Description of the Related Art

Conventional wind turbine blades often employ load-carrying spars arranged near the pitch axes of the blades. These spars are generally placed near the tallest portions of the blade's cross sections. FIG. 1, for example, is a cross section view of a conventional wind turbine blade 10. As shown in FIG. 1, the conventional wind turbine blade 10 is comprised of a spar 20 having spar caps 25 (i.e., flanges) connected to each other via a web 22. In the conventional art, the spar caps 25 are typically constructed of a solid slab of laminated fiber-reinforced plastic composite material. The fiber reinforcement of these slabs is generally dominated by unidirectional fibers aligned with a long axis of the blade. For a majority of the span of the blade (typically outboard of the spanwise station where the maximum chord length occurs), these spar caps 25 provide the overwhelming majority (i.e., typically greater than 80%) of the out-of-plane bending stiffness of the blade and carry most of the out-of-plane bending loads that dominate structural considerations of blade design. Hence the solid slab design for the spar caps, arranged generally down the centerline of the blade represents a structurally efficient approach to the design.

In the conventional art, the conventional blade 10 further includes an outer shell 30 which primarily serves the function of maintaining the aerodynamic characteristics of the blade 10. The shell 30, however, does serve some structural purposes, including contributing to the torsional rigidity of the blade 10 and carrying some of the shear load induced by bending of the blade 10. In outboard portions of a conventional art blade, shells are generally only lightly reinforced and exhibit relatively thin walls. As a result, these shells can be susceptible to local panel buckling that can induce cracks, delamination, debonding and other failures.

In the conventional art, the shells 30 are generally stiffened against buckling by use of a classic sandwich core construction in which the laminated skin is split into two layers sandwiching a light-weight core material that might be foam, wood, honeycomb, or other such material. Some companies have also developed three-dimensionally woven constructions (e.g., WebCore's Tycor product, now owned by Milliken, and ZPlex developed by 3TEX) that employ very light stitching normal to the fabric surface and light-weight foam rubber tubes to form an essentially hollow core product.

In some conventional designs, particularly designs using carbon fibers in the spar caps, the spar caps are thin enough that they can also be susceptible to local panel buckling. In some conventional designs core material is added between the spar cap and the inner skin of the blade to provide additional resistance to buckling.

As blades have grown in size, the quantity of core material required to prevent buckling has increased significantly. Core material is generally expensive, and some of the best core materials, such as balsa, are subject to price fluctuations and periodic supply constraints. The use of thick core can also complicate some manufacturing processes such as infusion of liquid resins. Therefore, reducing the quantity of core required is a generally desirable design objective.

Several solutions to the above problem can be envisioned. First, it is generally recognized that the primary source of this challenge is the use of centrally located spars, meaning that the nose and tail of the blade are lightly structurally reinforced, making them susceptible to buckling. So, one solution is to redistribute the material in the spar caps more broadly over the surface of the blade. While this may not be as structurally efficient as central spar caps from the perspective of stiffening and strengthening the blade against out-of-plane bending loads, it may reflect a more efficient overall structural approach in the sense that it provides extra structural reinforcement to the shells and thereby reduces the quantity of core required to stiffen the latter against panel buckling. The net result can be a blade of reduced weight and cost.

### SUMMARY

Example embodiments relate to a structure that includes pultrusions. A nonlimiting example of the structure is a wind turbine blade having pultrusions incorporated into the wind turbine blade's spar caps. Another nonlimiting example of the structure is a wind turbine blade having pultrusions configured to reinforce at least one of a tail and a nose of the wind turbine blade. Another nonlimiting example of the structure is a wind turbine blade having pultrusions configured to reinforce a shell of a wind turbine blade. Another nonlimiting example of the structure is a wind turbine blade having pultrusions configured to reinforce a web of the wind turbine blade.

Unlike the conventional art, the method proposed herein uses hollow pultruded or extruded parts as structural members. In some nonlimiting examples of the invention, hollow spaces are introduced into the cross section of a structural material. In some examples, the total volume of structural material is maintained essentially the same, but the material is spread out over a greater thickness by introducing hollow regions into the cross section. This increases the resistance of the structure to panel buckling without adding any weight to the structure. This allows for removal of other materials, such as a foam or a wood core, currently used to resist buckling. This reduces the weight and cost of the structure.

In accordance with example embodiments, a wind turbine blade may include an outer shell reinforced by a plurality of hollow pultrusions, wherein the plurality of hollow pultrusions are spaced apart from one another.

In accordance with example embodiments, a wind turbine blade may include a pultrusion arranged near a tail thereof.

In accordance with example embodiments, a wind turbine blade may include a pultrusion arranged near a nose thereof.

In accordance with example embodiments, a wind turbine blade may include a spar having a first flange and second flange, wherein the first flange is comprised of a plurality of hollow pultrusions arranged adjacent to one another.

### BRIEF DESCRIPTION OF THE DRAWINGS

Example embodiments are described in detail below with reference to the attached drawing figures, wherein:

FIG. 1 is a cross section view of a conventional wind turbine blade;

FIG. 2 is a cross section view of a wind turbine blade in accordance with example embodiments;

FIG. 3 is a partial cross section view of a wind turbine blade in accordance with example embodiments;

FIGS. 4A and 4B are cross section views of a wind turbine blade in accordance with example embodiments

FIG. 5A is a cross section view of a wind turbine blade in accordance with example embodiments;

FIG. 5B is a cross section view of a wind turbine blade in accordance with the conventional art;

FIG. 6 is a partial cross section view of a wind turbine blade in accordance with example embodiments;

FIG. 7 is a partial cross section view of a wind turbine blade in accordance with example embodiments;

FIGS. 8A-8G are partial views of pultrusions in accordance with example embodiments;

FIGS. 9A-9C are views of a wind turbine blade in accordance with example embodiments;

FIGS. 10A-10C are views of a wind turbine blade in accordance with example embodiments;

FIG. 11 is a cross section view of a wind turbine blade in accordance with example embodiments;

FIGS. 12A-12D are plan forms of wind turbine blades in accordance with example embodiments;

FIG, 13 is a cross section view of a wind turbine blade in accordance with example embodiments;

FIGS. 14A-14C are views of a wind turbine blade in accordance with example embodiments;

FIGS. 15A and 15B are views of pultrusions filled with a material in accordance with example embodiments; and

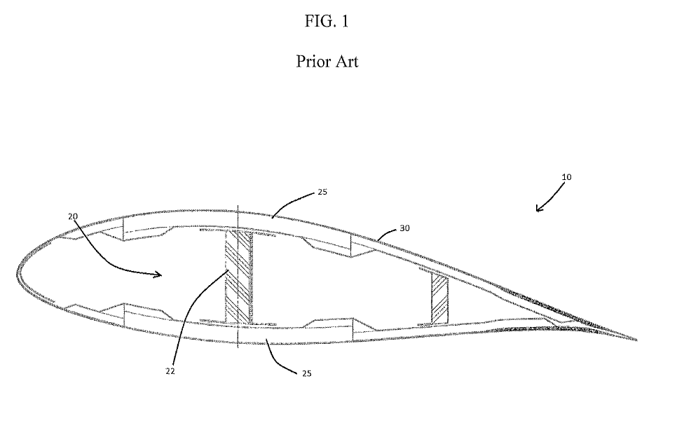

FIG, 16 is a flow chart illustrating an example of fabricating a wind turbine blade in accordance with example embodiments.

### DETAILED DESCRIPTION

Example embodiments will now be described more fully with reference to the accompanying drawings. Example embodiments are not intended to limit the invention since the invention may be embodied in different forms. Rather, example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a structure that includes pultrusions. A nonlimiting example of the structure is a wind turbine blade having pultrusions incorporated into the wind turbine blade's spar caps. Another nonlimiting example of the structure is a wind turbine blade having pultrusions configured to reinforce at least one of a tail and a nose of the wind turbine blade. Another nonlimiting example of the structure is a wind turbine blade having pultrusions configured to reinforce a shell of a wind turbine blade. Another nonlimiting example of the structure is a wind turbine blade having pultrusions configured to reinforce a web of the wind turbine blade.

Pultrusion, as is well known in the art, is a continuous process for manufacturing a composite material with a constant cross-section. In a pultrusion process, reinforced fibers may be pulled through a resin, a separate preforming system, and into a heated die, where the resin undergoes polymerization. Many resin types may be used in pultrusion including, but not limited to, polyester, polyurethane, vinylester and epoxy. This process produces lightweight strong engineered structures that may be usable with example embodiments. For example, this process may produce pultrusions which resemble tube structures that may or may not be conventional in shape and size.

Example embodiments disclose a wind turbine rotor blade constructed of a laminated composite material that includes hollow extruded members. In its simplest implementation, a spar cap of the wind turbine blade may be comprised of a pultruded member that has two layers separated by a hollow space. Web reinforcements between the two sides of the pultruded member may be sized and spaced laterally so as to optimize the local panel buckling resistance of the structural slab. In this sense, an entire spar cap of constant cross section could be pultruded as one part.

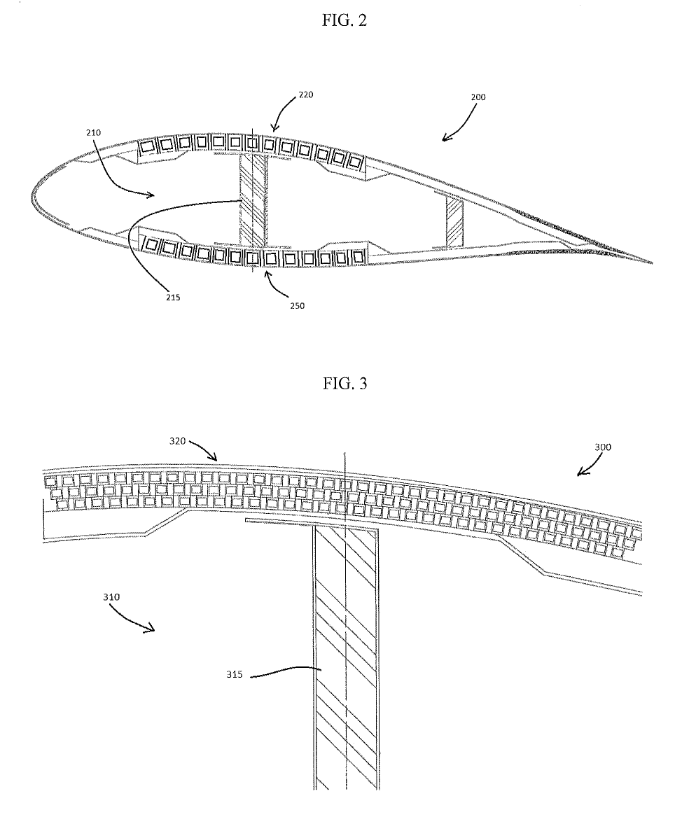

Example embodiments also disclose a wind turbine blade comprised of a plurality of hollow channels arranged to form a spar cap. For example, FIG. 2 illustrates a cross section of a wind turbine blade 200 in accordance with example embodiments. In this particular nonlimiting example, the wind turbine blade 200 includes a spar 210 comprised of a web 215, a first spar cap 220 and a second spar cap 250. In example embodiments, the first and second spar caps 220 and 250 are each comprised of a plurality of pultruded members (which form the hollow channels). For example, in example embodiments, each of the first and second pluralities of pultruded members forming the first spar cap 220 and the second spar cap 250 include thirteen hollow pultruded members having a substantially square profile. These pultruded members are arranged side-by-side to form the first and second spar caps 220 and 250. In example embodiments, using a plurality of protrusions (rather than a single one) may accommodate changes in the surface curvature and twist of the wind turbine blade 200. Furthermore, this approach has the additional advantage that the width of the spar caps 220 and 250 may be optimized in different spanwise regions of the blade 200 by adjusting the number of pultrusions placed laterally.

Example embodiments are not limited by the features illustrated in FIG. 2. For example, rather than providing a single row of pultrusions to form the first and second spar caps 220 and 250, the first and second spar caps may be comprised of multiple rows of pultrusions. For example, FIG. 3 illustrates a partial cross-section view of a wind turbine blade 300 in accordance with example embodiments. As shown in FIG. 3, the wind turbine blade 300 includes a spar 310 comprised of a web 315 and a first spar cap 320. As shown in FIG. 3, rather than forming a spar cap as a single row of pultrusions (as shown in FIG. 2), the spar cap 320 of example embodiments includes three rows of hollow pultrusions. Furthermore, it is not required that each pultrusion be of the same material composition as any or all of the other pultrusions in a spar cap.

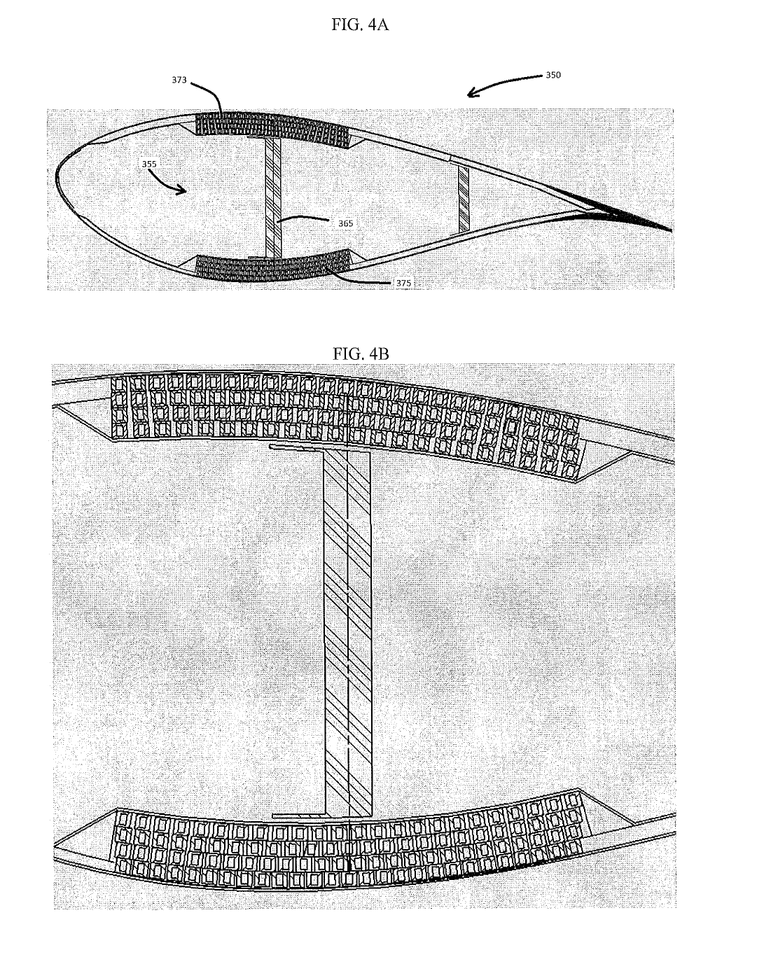

FIGS. 4A and 4B illustrate yet another example of a wind turbine blade 350 in accordance with example embodiments. More specifically, FIG. 4A illustrates a cross section of the wind turbine blade 350 in accordance with example embodiments and FIG. 4B illustrates a close up view of a spar 355 of the wind turbine blade 350 in accordance with example embodiments.

Referring to FIGS. 4A and 4B, the wind turbine blade 350 in accordance with example embodiments may include a spar 355. In example embodiments, the spar 355 may include a first spar cap 373 and a second spar cap 375. In example embodiments, each of the first and second spar caps 373 and 375 may include a plurality of pultrusions. For example, as shown in FIGS. 4A and 4B, each of the first and second spar caps 373 and 375 may include four rows of hollow pultrusions.

The number of rows of pultrusions is not meant to be a limiting feature of example embodiments as the number of rows may vary. For example, in example embodiments, the spar caps of example embodiments may include a single row of pultrusions (as shown in FIG. 2), two rows of pultrusions, three rows of pultrusions (as shown in FIG. 3), four rows of pultrusions (as shown in FIGS. 4A and 4B), or more than four rows of pultrusions. Furthermore, the spar caps of the spars are not required to have the same number of rows of pultrusions. For example, although the spar caps 373 and 375 of the wind turbine blade 350 each include four rows of pultrusions, in example embodiments, the second spar cap 375 may include more or less than four rows of pultrusions when the first spar cap 355 includes four rows of pultrusions. Furthermore, it is not required that the pultrusions be arranged in rows.

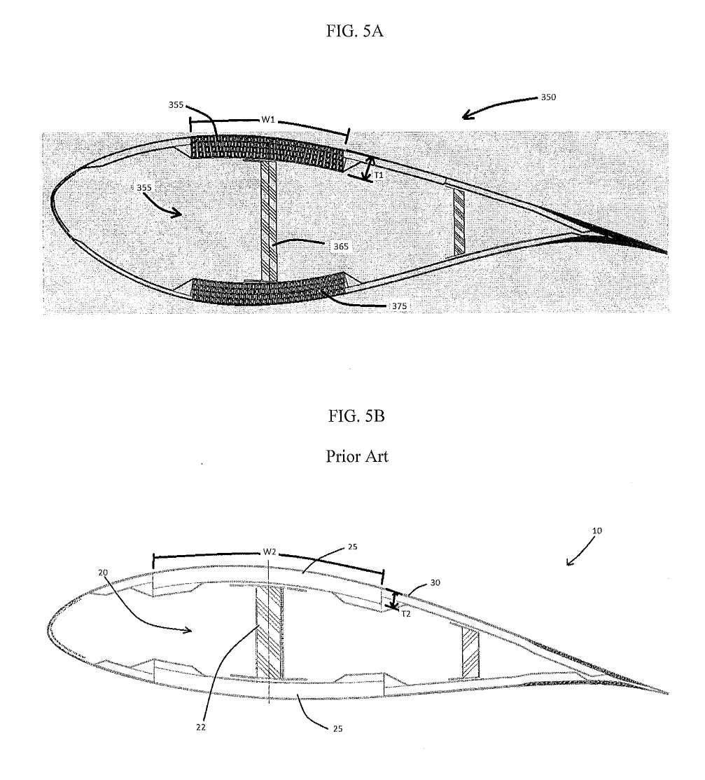

FIGS. 5A and 5B illustrate an inventive concept of example embodiments. In particular, FIG. 5A illustrates the wind turbine blade 350 in accordance with example embodiments while FIG. 5B illustrates a wind turbine blade 10 in accordance with the conventional art. In FIG. 5A, the wind turbine blade 350 is illustrated with the first spar cap 355 having a width W1 and a thickness T1. Similarly, the wind turbine blade 10 of FIG. 5B is illustrated as having a width W2 and a thickness of T2. In example embodiments, the widths W1 and W2 are not required to be the same. However, in example embodiments, if the widths W1 and W2 are the same, the thickness T1 of the first spar cap 355 may be greater than the thickness T2 of the conventional spar cap 25 since the spar cap 355 is comprised of pultrusions having hollow spaces. Thus, in example embodiments, the total amount of material of the wind turbine blade 355 in accordance with example embodiments may be about the same as the total amount of material used to fabricate the wind turbine blade 10 in accordance with the conventional art.

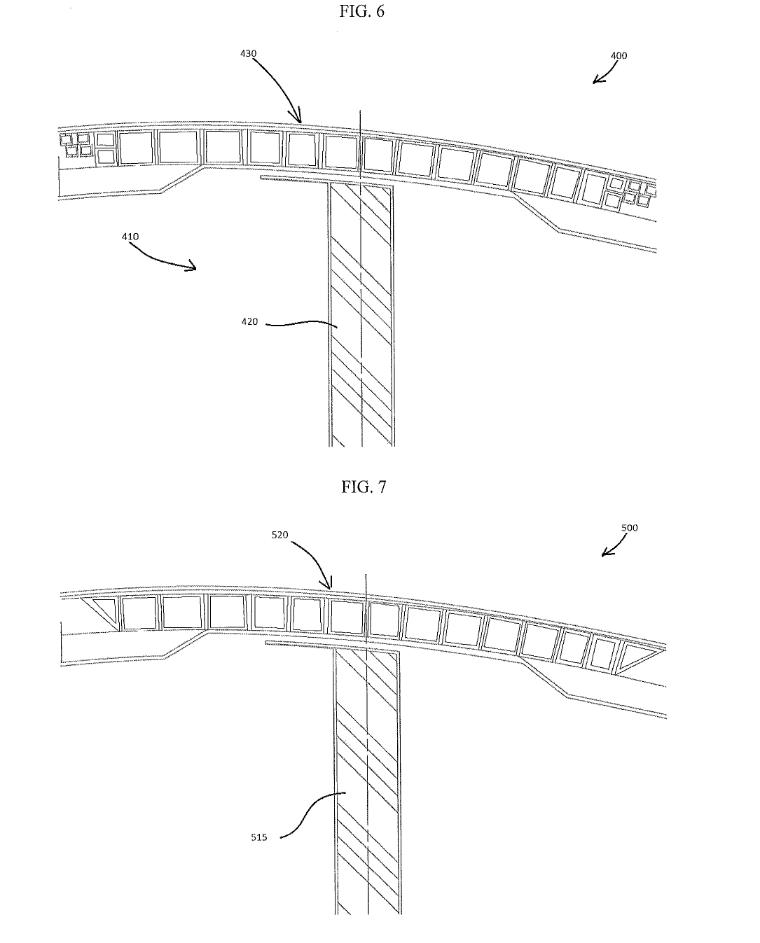

In FIGS. 2-4B, each of the pultrusions forming the spar caps is shown as having a relatively uniform size. This aspect of example embodiments, however, is not intended to limit the invention. For example, FIG. 6 illustrates a partial cross section view of a wind turbine blade 400 in accordance with example embodiments. As shown in FIG. 6, the wind turbine blade 400 includes a spar 410 comprised of a web 420 and a spar cap 430. In example, embodiments, the spar cap 430 is comprised of several pultrusions having different sizes. For example, each of the ends of the spar cap 430 is comprised of four pultrusions having relatively small cross sections while a middle portion of the spar cap 430 is comprised of thirteen pultrusions having relatively large cross sections. Between the ends and the middle portion are pultrusions having an intermediate size. This aspect of example embodiments allows pultrusions of different sizes or shapes to be used in a fashion so as to optimize the construction of the spar cap 430. For example, smaller pultrusions may be used at the edges of the spar cap to taper the stiffness transition at the edges. Furthermore pultrusions used at the edges of the spar cap may not be of the same size as pultrusions in the middle portion. The pultrusions on the edge may not be comprised of the same material or of the same cross-sectional shape. As such pultrusions in different positions may have different physical or mechanical properties.

In FIGS. 2-4B, the example wind turbine blades 200, 300, 350, and 400 are illustrated as being comprised of tubular pultrusions having substantially square cross-sections. This aspect of example embodiments is not meant to limit the invention. For example, FIG. 7 illustrates another nonlimiting example of a wind turbine blade 500. As shown in FIG. 7, the example wind turbine blade 500 includes a web 515 and a spar cap 520 comprised of a plurality of pultrusions. A middle portion of the spar 520 is comprised of thirteen pultrusions having a substantially square cross-section whereas ends of the spar 520 are comprised of pultrusions having a triangular cross-section.

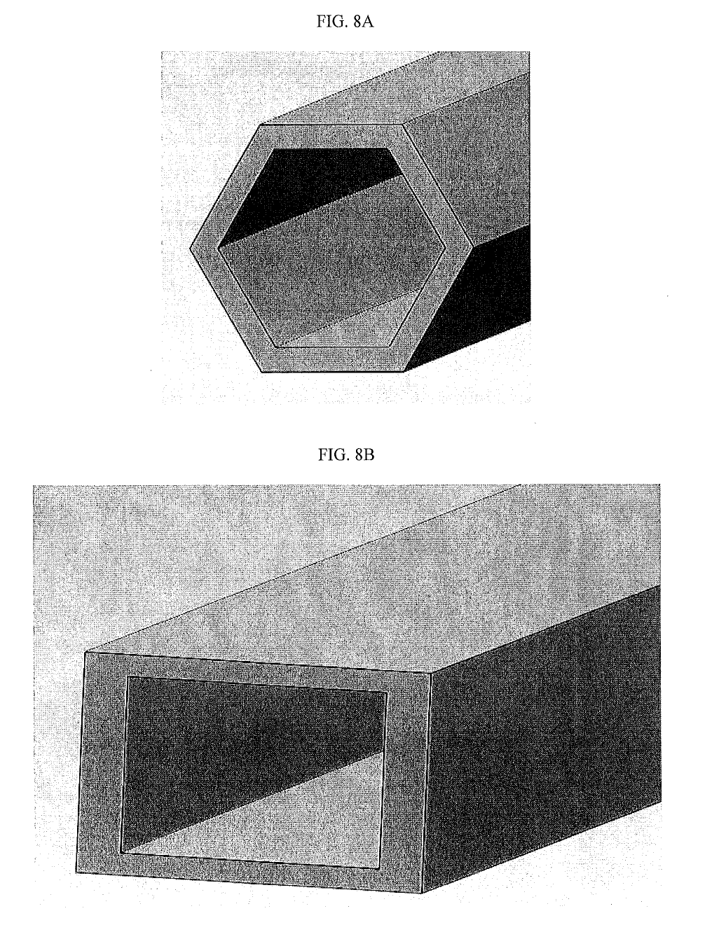

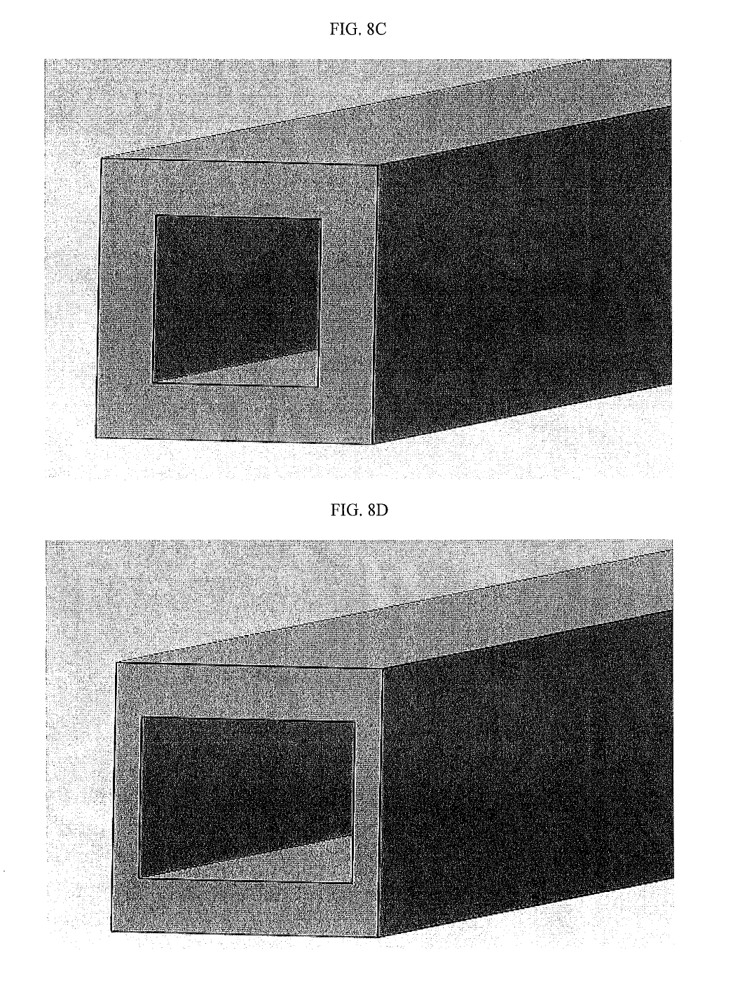

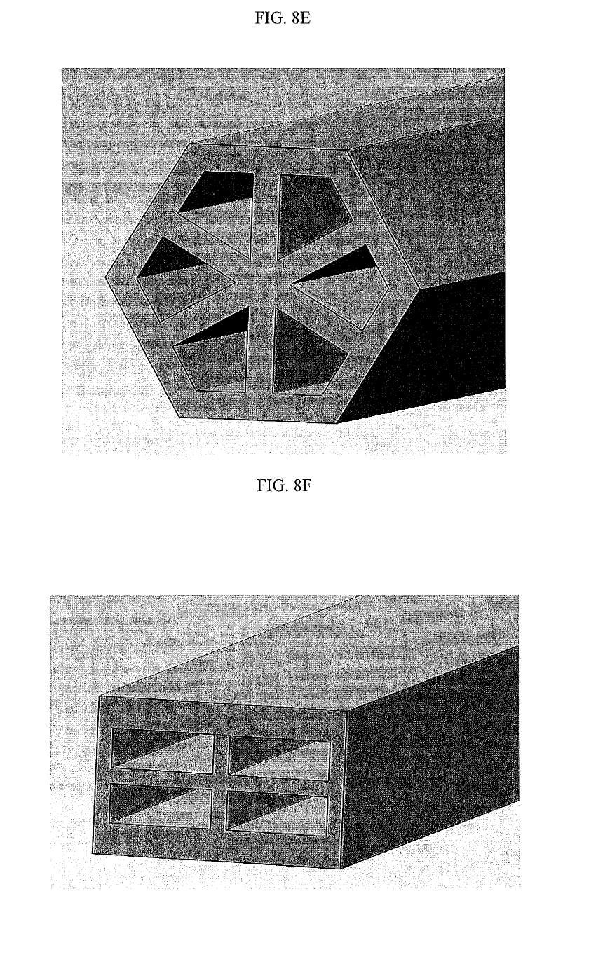

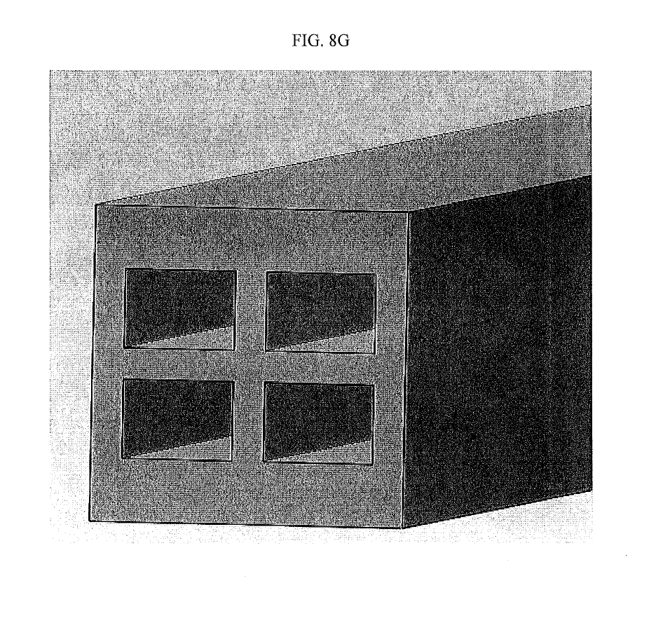

In example embodiments, cross sections of the pultrusions may take various shapes. For example, as shown in FIGS. 2-7, the pultrusions may be a hollow rectangular tube or a hollow triangular tube. Alternatively, the cross section of the pultrusions may be trapezoidal to better accommodate curvature of the outer surface of the example blades. In addition, top and bottom faces of the trapezoidal cross section could incorporate some curvature to even better conform to the curvature of the outer surface of the global structure. In example embodiments, the cross sections of the pultrusions may be hexagonal (see FIG. 8A), a shape that has the advantage of accommodating close packing while enabling locking of closely packed pultrusions inside of a mold. The cross section may alternatively be circular, elliptical, or otherwise fully or partially rounded, such as a D channel. The cross section of the pultrusions, however, does not have to be a closed shape and could have an open shape, such as, but not limited to, an L, I, Y, V, H, T, C, X, S, Z, A, Ω or other open shape.

In example embodiments, the pultrusions may include internal reinforcements. For example, a substantially rectangular or trapezoidal cross section may include multiple lateral and/or vertical members for additional reinforcement. As another example, a hexagonal section may contain a spoke (i.e., a wagon wheel arrangement of FIG. 8E). As yet another example, FIG. 8B illustrates another example of a pultrusion wherein the pultrusion has a rectangular outer profile and a rectangular inner profile and FIG. 8F illustrates the pultrusion having internal reinforcing members. As yet another example, FIG. 8C illustrates an example of a pultrusion having an square shaped outer profile and a square shaped inner profile and FIG. 8G illustrates the pultrusion having internal reinforcing members. Of course, in example embodiments, it is not necessary than an outer profile and an inner profile of a hollow pultrusion be the same. For example, as illustrated in FIG. 8D, an outer profile of a pultrusion may be square shaped wherein an inner profile of the pultrusion may be rectangular shaped.

In example embodiments, the pultrusions may be comprised of a composite laminated material. For example, the pultrusions may be formed of a unidirectional fiber-reinforced plastic composite. The construction may be exclusively unidirectional fibers, but they could also be pultruded with cross-fiber (90 degrees), double bias (+/−45 degree) or other reinforcement in all or part of the construction. In example embodiments, the fibers may be extruded as rovings, as nonwoven or woven fabrics, or as other appropriate constructions. In example embodiments, use of double bias may be used on the “web” members of the pultrusion. Furthermore, fibers might include carbon, any type of glass, basalt, aramid, natural fibers (e.g., flax) or other high-strength fiber. In example embodiments, the fibers may be continuous fibers, short fibers, or a combination thereof. In example embodiments, the plastics may be thermoset or thermoplastic resins. In example embodiments, the pultrusions may instead be metal extrusions. In the alternative, the pultrusions may instead be a hollow wood structure with long wood fibers oriented parallel to the long axis of the structure. In example embodiments, the pultrusions may be a hybrid of composite, metal, and/or wood.

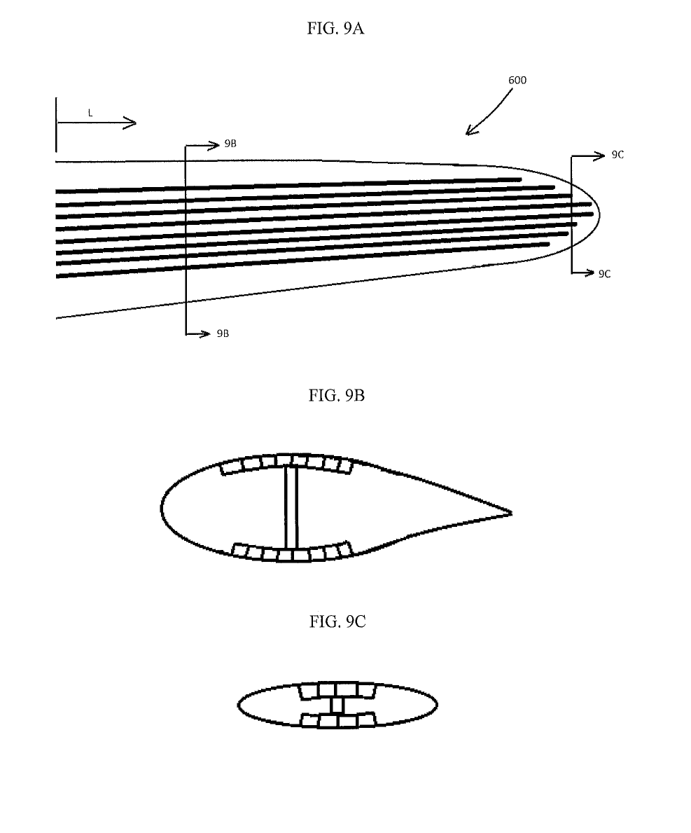

FIG, 9A is a drawing of a blade 600 in accordance with example embodiments. Many of the features of the blade 600, however, are omitted for the sake of clarity. As shown in FIG. 9A, the profile of the blade 600 may change along a length L of the blade. In example embodiments, the blade 600 may include a spar having spar caps comprised of a plurality of pultrusions as described above. In example embodiments, the pultrusions may have different lengths in accordance with a profile of the blade.

FIG. 9B is a cross section view of the blade 600 taken through line 9B-9B of FIG. 9A and FIG. 9C is a view of the blade 600 taken through line 9C-9C of FIG. 6A. As shown in FIG. 9B, the spar caps, in one portion of the blade 600, may be comprised of eight pultrusions whereas the spar caps of FIG. 9C are comprised of only four pultrusions. Thus, in example embodiments, different portions of the blade 600 in accordance with example embodiments may have a different number of pultrusions comprising a spar cap.

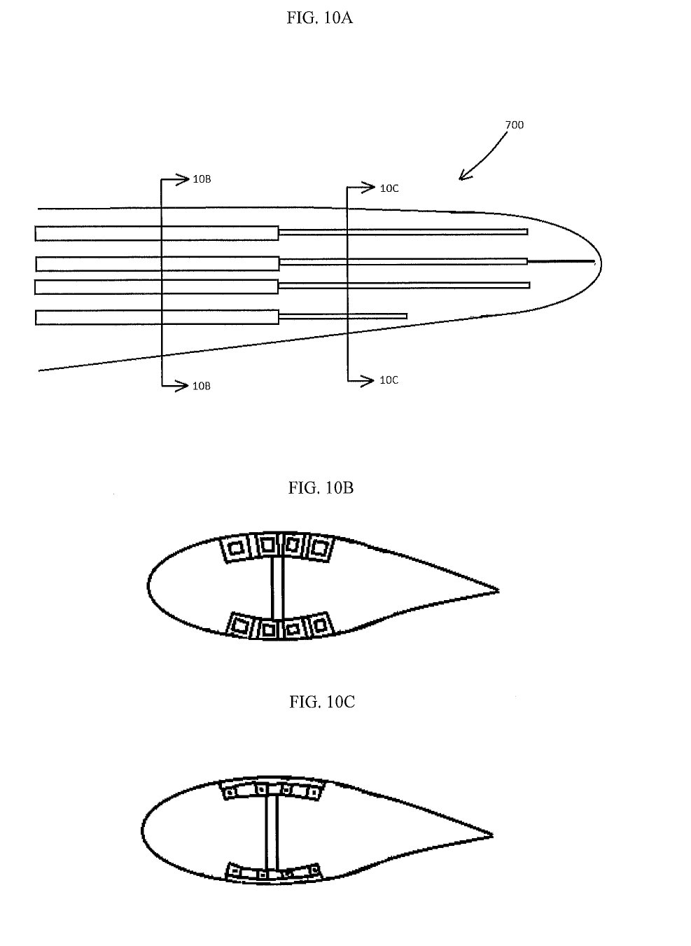

In another example, large pultrusions may be stepped down to smaller pultrusions at a given spanwise station. For example, as shown in FIG. 10A, pultrusions forming a spar cap at a first section, for example, as shown in FIG. 10B, may have a cross section of a first size. However, another section, for example, as shown in FIG. 10C, may have a same number of pultrusions, but with a second size that may be smaller than the first size. In example embodiments, the pultrusions of the second section may be nested and lapped with the pultrusions of the first section for some minimal distance required to transition load. For example the pultrusions of the second section and the pultrusions of the first section may be associated with one another in a telescoping manner (for example, portions of the pultrusions of the second section may be inserted into portions of the pultrusions of the first section). This would enable tailoring of the structural properties in areas of the blade with differing loads and geometry. This approach has the added advantage that the pultrusions may be distributed in the chordwise direction in a more optimal manner.

In example embodiments, pultrusions could “step up” in size and then “step down” in size along a length of a blade. For example, it is conceivable that a middle portion of a wind turbine blade experiences relatively high stresses when compared to other portions of the blade. In this case, the middle portion may be provided a relatively large pultrusion to accommodate relatively high stresses. Outside of the high stress zone, however, smaller pultrusions may be provided. Thus, in example embodiments, a relatively large longitudinal pultrusion may be connected at both ends to relatively small pultrusions.

In example embodiments, the pultrusions do not need to be clustered at the center to form a centrally located spar cap. The pultrusions may be spread out laterally in a highly optimized manner to minimize the amount of structural material required to accomplish both stiffening of the blade against bending and resistance of local panel buckling. In this fashion, the concept is significantly superior to conventional technology that uses flat extruded plates. The hollow channels, for example, may be distributed in the shell of the blade which may provide significant resistance to panel buckling. This approach has the added advantage in that the pultrusions may be arranged in such a manner as to more closely follow the load paths within the blade. For example, the pultrusions may be arranged so as to spread out at the root of the blade with each pultruded channel connecting to a mechanical fastener at a root designed to attach the blade to second structure (e.g., attaching a wind turbine blade to a pitch bearing or rotor hub).

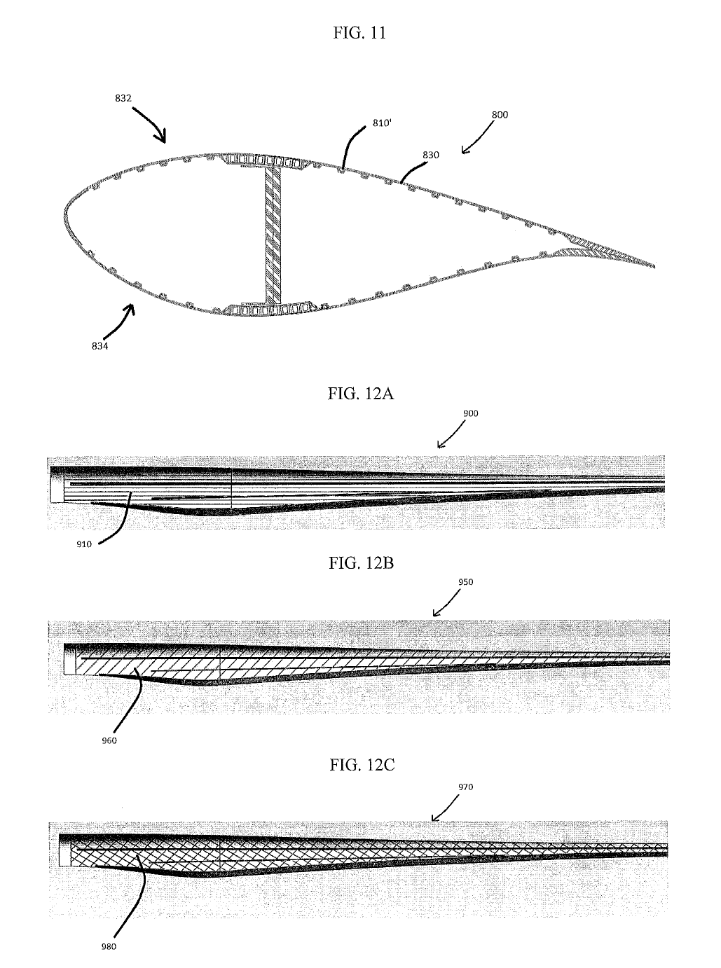

FIG. 11 is an example of a blade 800 in which pultrusions 810′ may be arranged near or in the shell 830 of the blade 800. As shown in FIG. 11, the pultrusions 810′ may be arranged in an upper portion 832 of the shell 830 and/or a lower portion 834 of the shell 830 and may run along a length of the blade. Also as shown in FIG. 11, the pultrusions 810′ may be spaced apart from one another and a spacing of the pultrusions 810′ may be, but is not required to be, substantially equal. Also, in example embodiments, the shell 830 may be comprised of a first layer and a second layer and the pultrusions 810′ may be sandwiched between the first and second layers. In example embodiments, the first and second layers may be, but is not required to be, made from a relatively light weight composite laminated material.

In example embodiments, the pultrusions 810′ may be indirectly connected to one another via the shell 830, however, in example embodiments, the blade 800 may be configured so that at a given cross section, for example, as shown in FIG. 11, the pultrusions 810′ are not connected to each other by an additional structure. For example, in example embodiments, the pultrusions 810′ may or may not be connected to each other by an additional structure which may, or may not be, another type of pultrusion, or another pultrusion having differing material construction, physical properties, and/or mechanical properties as compared to the pultrusions to which the subsequent pultrusions are attached. Furthermore, at the given cross section, the pultrusion 810′ may only be directly connected to the shell 830 and not another structure.

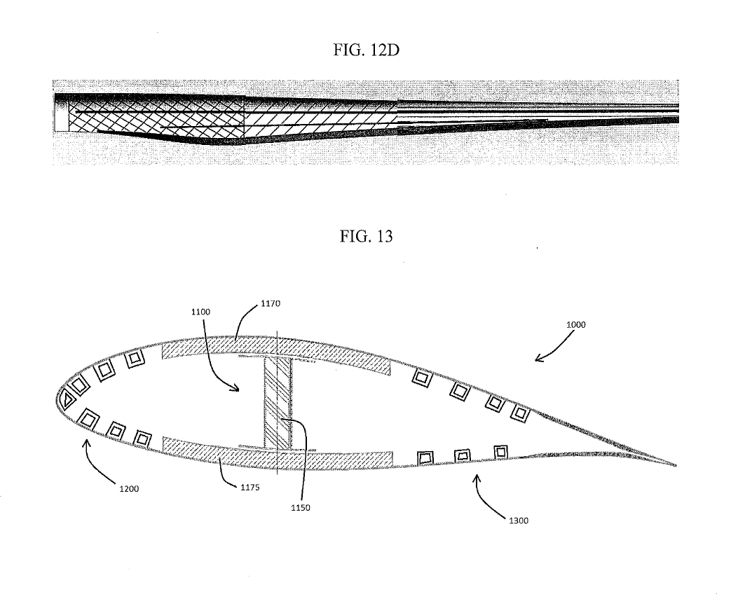

FIGS. 12A-12C illustrate planform, views of wind turbine blades 900, 950, and 970 in accordance with example embodiments. In example embodiments, the wind turbine blades 900, 950, and 970 may have a cross-sections substantially similar to the cross-section illustrated in FIG. 11, thus a detailed description thereof is omitted for the sake of brevity. However, as illustrated in FIG. 12A, the pultrusions 910 associated with the shell of the wind turbine blade 900 may run along a substantial length of the wind turbine blade 900. In example embodiments, the wind turbine blade 950 of example embodiments includes pultrusions 960 oriented at an angle from a pitch line of the blade. In example embodiments, the angle, for example, may be about 45 degrees from the blade's pitch axis. In example embodiments, the wind turbine blade 970 includes pultrusions 980 that are arranged in a cross-shaped pattern which may impart significant rotational stiffness to the wind turbine blade 970.

In example embodiments, different sections may include a different grouping of pultrusions in the shell. For example, as shown in FIG. 12D, a first section of a wind turbine blade may include a group of pultrusions arranged similar to the pultrusions 980 of example embodiments, a second section of the wind turbine blade may include a second group of pultrusions similar to the pultrusions 960 of the wind turbine blade 950, and a third section of the wind turbine blade may include a third group of pultrusions similar to the pultrusions 910 of the wind turbine blade 900.

Methods of constructing the blades using these pultrusions could vary widely, and might include embedding the pultrusions into a shell of a blade, sandwiched between inner and outer skins of the blade. In example embodiments, the skins could be: 1) put down dry and infused with liquid resin before curing; 2) formed from fiber-reinforcements preimpregnated with resin (i.e., prepregs) and then cured; or 3) formed from an alternative process. In example embodiments, the pultrusions could be used on the inside surface of the blade shell, by either co-molding them with the outer shell or by bonding them in a secondary process to the outer skin.

In example embodiments, the pultrusions could be used in conjunction with more conventional blade construction features. For example, the pultrusions could be used in conjunction with a classic sandwich core structure to reduce the quantity of core material used without entirely eliminating the core material.

In example embodiments, the pultrusions could be used in conjunction with a classic thick slab spar cap. In this application, a “nose” and a “tail” of a blade refer to portions of the blade forward and aft of the blade's spar cap, if one is present. The pultrusions could be used in the nose or tail of a blade with a conventional slab spar cap to strengthen the nose or tail structure against panel buckling without replacing the conventional spar cap. In addition, the pultrusions could be used on top of a thick slab spar cap to strengthen the spar cap against local panel buckling.

In example embodiments, the pultrusions could be used as parts of a distinct spar or spars to which the outer shells of the blade could be bonded. The pultrusions may also be used in secondary blade structures, such as the shear webs, to strength those against local panel buckling. In example embodiments, a single large pultrusion could be used to form a distinct spar or web structure to be used as part of an overall structural assembly. In example embodiments, the pultrusions could be used both as part of distinct spars and/or shear webs or other components and also in the shell of the blade.

Although example embodiments are directed to wind turbine blades that incorporate pultrusions, the invention is not limited thereto as the inventive concepts may be applied in various other structures such as, but not limited to, a wing of a rotorcraft. Furthermore, although example embodiments utilize pultrusions as a structural member, it is clear that other members, such as extruded members, may be used in their place. Furthermore, other engineered structures may be used in lieu of either the pultrusions or extrusions. For example, any structural member, regardless as to how it was formed, having the properties of the pultrusions may be used in lieu of the pultrusions.

Thus far, example embodiments describe a wind turbine blade having spar caps comprised of pultrusions. This aspect of example embodiments, however, is not intended to limit the invention. For example, FIG. 13 illustrates another example of a wind turbine blade 1000 in accordance with example embodiments. In FIG. 13, the wind turbine blade 1000 is illustrated as including a spar 1100 having a web 1150 joining a first spar cap 1170 to a second spar cap 1175. In example embodiments, the spar caps 1170 and 1175 may be conventional in that they may be formed of a substantially solid slab of laminated fiber-reinforced plastic composite material. However, in FIG. 13, a first plurality of pultrusions 1200 is provided to reinforce the nose of the wind turbine blade 1000 and a second plurality of pultrusions 1300 is provided to reinforce a tail of the wind turbine blade 1000.

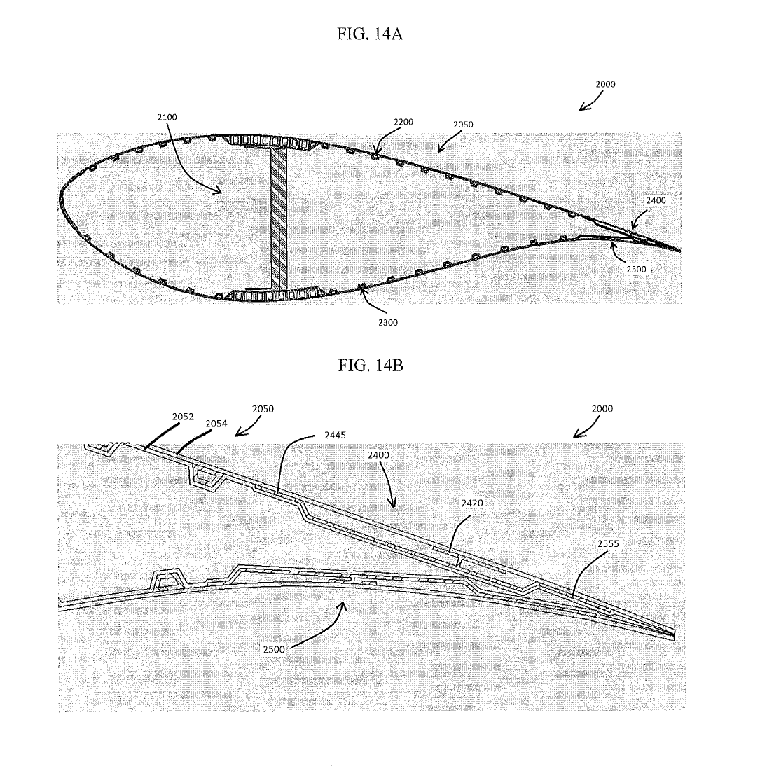

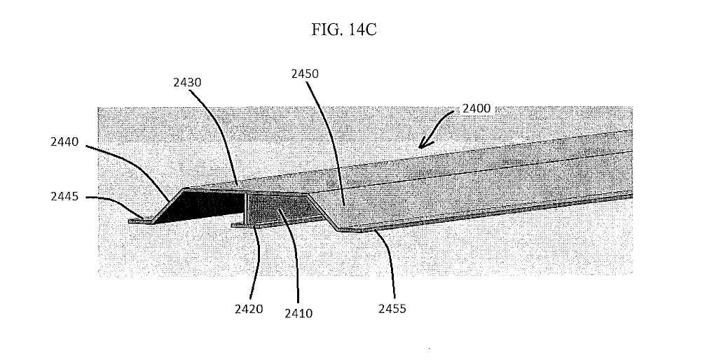

FIGS. 14A to 14C illustrate another example of a wind turbine blade 2000 in accordance with example embodiments. As shown in FIGS. 14A to 14C the wind turbine blade 2000 may include a shell 2050 enclosing a spar 2100. In this particular nonlimiting example, the wind turbine blade 200 may include a first plurality of pultrusions 2200 arranged in an upper part of the shell 2050 and a second plurality of pultrusions 2300 arranged in a lower part of the shell 2050 to strengthen and reinforce the shell 2050. However, in this particular nonlimiting example, the tail of the wind turbine blade 2000 may be reinforced by pultrusions 2400 and 2500 which may have a relatively open section. FIG. 14B, for example illustrates a close up view of the tail of the wind turbine blade 2000 in accordance with example embodiments. As can be seen in FIG. 14B, each of the pultrusions 2400 and 2500 (as well as the pultrusions 2200 and 2300) may be sandwiched between two layers 2052 and 2054 that may form the shell 2050. In example embodiments, the two layers may be, but is not required to be, formed of a laminated composite material.

FIG. 14C illustrates a partial perspective view of the pultrusion 2400 usable with example embodiments. This particular pultrusion 2400, however, is for the purposes of illustration only and is not intended to limit example embodiments. As shown in FIG. 14C, the pultrusion 2400 may include a primary member 2430 from which a first flange 2410, a second flange 2440, and a third flange 2450 may extend. In example embodiments, each of the first flange 2420, the second flange 2440, and the third flange 2450 may include contact members configured to contact a surface of the shell 2050. For example, the first flange 2410 may include a first contact member 2420, the second flange 2440 may include a second contact member 2445, and the third flange 2450 may include a third contact member 2455. In example embodiments, each of the first, second, and third contact members 2420, 2445, and 2455 may be substantially parallel to an outer surface of the wind turbine blade as shown in at least FIG. 14B. In example embodiments, the first flange 2410 may, or may not be comprised of materials with dissimilar physical and/or mechanical properties to the materials of the second flange 2430.

Although FIGS. 14A-14C provide a specific example of an open pultrusion 2400 and 2500 usable with example embodiments, the invention is not limited thereto. For example, in example embodiments, the pultrusion 2400 is illustrated as including three flanges, however, in example embodiments the pultrusion 2400 may only include two flanges by omitting the first flange 2410. As yet another example, the pultrusion may include another flange between the second and third webs 2440 and 2450. In addition, although FIG. 14C illustrates the second and third flanges 2440 and 2450 as being inclined with respect to the primary member 2430, example embodiments are not limited thereto. For example, the second and third flanges 2440 and 2450 may be perpendicular to the primary member 2430.

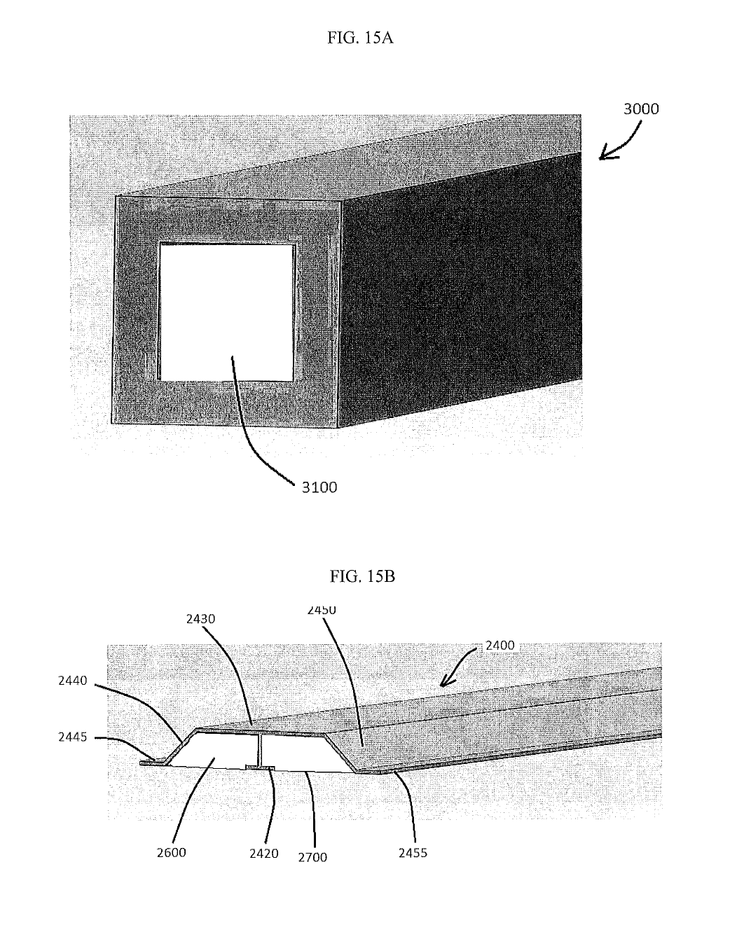

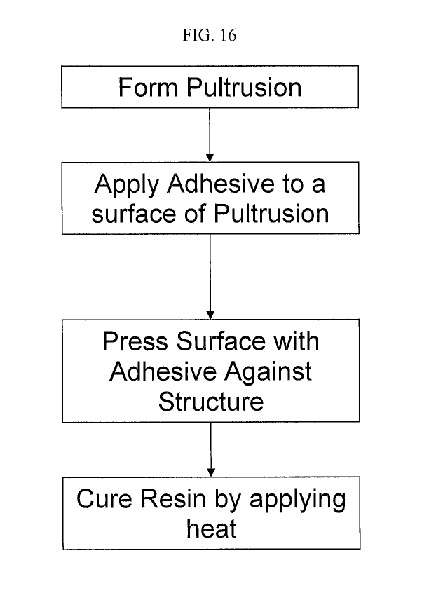

As explained and illustrated above, pultrusions of example embodiments may be substantially hollow closed members or may be open members as illustrated in at least FIGS, 14A-14C. However, this is not intended to be a limiting feature of example embodiments. For example, in example embodiments, the pultrusions may be at least partially filled with a material of a lighter density than the main material forming the pultrusion, for example, a closed-cell foam. FIG. 15A, for example, illustrates a pultrusion 3000 filled at least partially with the material 3100, which may be, but is not limited to, a light weight material such as a closed-cell foam. FIG. 15B illustrates an example the open section pultrusion 2400 at least partially filled with the light weight material 2600 and 2700, which may be, but is not limited to, a closed cell foam. The material may prevent resin, or another material, from filling the space enclosed by the pultrusion. In example embodiments, the material used to fill a pultrusion may be substantially lighter than traditional core materials used in wind turbine blade design. In example embodiments, the material 2600 may, or may not be the same as material 2700. For example material 2600 may, or may not have the same physical and/or mechanical properties as material 2700. Thus, the resulting structure may be lighter than a conventional wind turbine blade.

As explained above, a hollow pultrusion may be filled with a light weight material. In a technical sense, it is understood one skilled in the art might consider the resulting pultrusion non-hollow since it is now filled, or partially filled, with a filling material. However, in this application, a pultrusion is considered hollow even if the pultrusion is filled, or partially filled, with a filling material such as, but not limited to, a closed cell foam.

In example embodiments, various methods may be used to manufacture a wind turbine blade. For example, in example embodiments, the wind turbine blades according to example embodiments may be made by laying the pultrusions into a sandwich-type construction of dry glass, and the entire shell structure could be infused with liquid resin. Alternatively, a spar structure formed from multiple pultrusions which may be formed as an independent structure and is then laid in. As yet another example, the spar structure may be formed as an independent structure and then bonded onto some wind turbine shells.

In example embodiments, some methods of forming a wind turbine blade may include infusion of a liquid resin. However, in order to prevent liquid resin from flowing into the hollow channels of the pultrusions, example embodiments include an operation wherein ends of the pultrusions are sealed. In example embodiments the method may include sealing the ends of the pultrusions with a resin, for example, a high strength thixotropic compound, or a cap, before a liquid resin infusion operation. In the alternative, the ends may be capped or plugged with a material, for example, a closed-cell foam.

In example embodiments, surfaces of the pultrusions may be covered with a resin, for example, a B-stage resin. In example embodiments, the resin may only be partially cured which may allow for easy handling and storage of the pultrusions. In example embodiments, the pultrusions having the resin applied to surfaces thereof, may be attached to another structure by pressing the pultrusion against the structure and applying heat to fully cure the resin. Thus, in example embodiments, an operation of liquid resin injection to attach a pultrusion to a structure may be avoided.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A wind turbine blade comprising:
an outer shell reinforced by a first plurality of hollow pultrusions spaced apart from one another.

2. The wind turbine blade of claim 1, wherein the first plurality of hollow pultrusions have substantially equal spacing along the outer shell.

3. The wind turbine blade of claim 2, wherein the first plurality of hollow pultrusions extend along a length of the blade.

4. The wind turbine blade of claim 2, wherein the first plurality of hollow pultrusions are oriented at an angle with respect to a pitch axis of the wind turbine blade.

5. The wind turbine blade of claim 2, wherein first plurality of hollow pultrusions is arranged in cross-shaped pattern.

6. The wind turbine blade of claim 1, wherein lengths of the hollow pultrusions vary so that a number of hollow pultrusions passing through a first cross-section of the wind turbine blade is different from a number of hollow pultrusions passing through a second cross-section of the wind turbine blade,

7. The wind turbine blade of claim 1, wherein a size of the hollow pultrusions in a first section of the wind turbine blade is different from a size of hollow pultrusions in a second section of the wind turbine blade.

8. The wind turbine blade of claim 1, wherein the outer shell is comprised of a first layer and a second layer and the plurality of hollow pultrusions is sandwiched between the first layer and the second layer.

9. The wind turbine blade of claim 1, wherein the plurality of hollow pultrusions are filled with a material.

10. The wind turbine blade of claim 9, wherein the material is a light weight closed-cell foam,

11. A wind turbine blade comprising;
a pultrusion arranged near at least one of a nose and a tail of the wind turbine blade.

12. The wind turbine blade of claim 11, wherein the pultrusion is an open section pultrusion,

13. The wind turbine blade of claim 12, wherein the pultrusion includes a primary member and at least two flanges extending from the primary member.

14. The wind turbine blade of claim 13, wherein the pultrusion further includes at least two contact members, the at least two contact members being substantially parallel to an outer surface of the wind turbine blade.

15. The wind turbine blade of claim 11, further comprising:
a shell comprised of two layers, wherein the pultrusion is sandwiched between the two layers.

16. A wind turbine blade comprised of:
a spar having a first flange and second flange, wherein the first flange is comprised of a plurality of hollow pultrusions arranged adjacent to one another.

17. The wind turbine blade of claim 16, wherein the plurality of hollow pultrusions are arranged to form at least two rows of pultrusions.

18. The wind turbine blade of claim 17, wherein hollow pultrusions arranged near ends of the first flange are smaller than pultrusions arranged near a middle of the first flange.

19. The wind turbine blade of claim 17, wherein pultrusions arranged at ends of the first flange have a different shape than pultrusions arranged near a middle of the first flange.

20. The wind turbine blade of claim 16, further comprising:
a material filling the plurality of hollow pultrusions.
